(19) United States
(12) Patent Application Publication
(10) Pub. No.: US 2006/0163301 A1
(43) Pub. Date: Jul. 27, 2006

(54) Bottle tethering device

(76) Inventors: Christine M. Rhodes, Oceanside, CA (US); Jarrid D. Rhodes, Oceanside, CA (US); Anna L. Matuszak, Oceanside, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/043,643

(22) Filed: Jan. 25, 2005

(51) Int. Cl. B60R 7/00

(52) U.S. Cl. 224/409

(57) ABSTRACT

A device for safely retaining an object such as a child's bottle or other object consisting of interrelated straps of webbing or other materials employing tensionally locked slidably compression buckles. One or all of the straps are adjustable for length. The attachment and retention straps are placed circumferentially around the objects to be attached. The strap engaging the bottle or other component is best compressively engaged and employs buckles having a tensional release and dexterity requirement lacking in young children.

### BACKGROUND OF THE INVENTION

1. Field of the Invention

The present invention relates to the area of bottles, containers, cups and accessories and their controlled constraint. The present invention is specifically directed toward but is not limited to the field of safe baby bottle or accessory restraint on baby and child strollers, car seats, back packs and the like.

A device is disclosed for parents that simultaneously provides increased baby bottle or accessory restraint capabilities through a curved or arched adjustable frictional engagement buckle and precludes or reduces accidental or premeditated release by the child through means of increased tensional buckle coupling forces.

Devices such as those described herein are intended primarily for use during recreational and rehabilitational outings as noted but could easily include use during play, feeding or sleeping periods with associated equipment such as high chairs and cribs or even clothing.

2. Prior Art

From time immemorial there has been a fundamental need for humans to retain items relating to their security, sustenance and other personal considerations. This can be said of both adults and children. One important area demonstrating such a need is the area of child nurturing. As an example, during walks or drives in a stroller, back pack or car seat a child may need to have a baby bottle available for feeding purposes. As children and babies generally lack the muscle development and coordination of older children, they often have difficulty maintaining their grasp on their bottles and toys. Younger children and infants also tend to have short attention spans and do not generally appreciate the consequences of actions taken by them. A child may drop a toy on the floor when it no longer interests them. Such an item might even be dropped without the child even knowing that the item has been discarded. Some times a child may even choose to throw or drop such objects of his own accord. Dirt, animal debris, insects and other non-hygienic materials generally present on floors, streets and surfaces are very likely to contaminate the object dropped. In the case of a baby's bottle such contamination could easily cause the child to become ill as younger children tend to taste everything within their reach. The replacement costs of lost or damaged articles is another problem faced by the parent and family lacking appropriate device constraints.

Finally and most importantly, as the curiosity of a child is often directed to objects close at hand, a constraining device must possess not only utility as such but additionally must incorporate an increased resistance to accidental or intended release by the child's inquiring mind and fingers and be exceedingly safe during intended and unintended use. Many solutions have been put forth with the intent to effect such a capability, from ropes directly tied to the user or his appendages to various more or less complicated associations of rings, clips, loops, chains, lassos, hook and loop assemblages and the like.

As shall be demonstrated individually in detail below, each of the noted approaches suffer from one or more shortfalls either specific to the implementation or generic to the approach that detracts from the efficacy of a device of the type as is herein described.

U.S. Pat. No. 2,781,959 describes a device to hold in constraint generally, bottles and cans, but as noted not limited to those items as such. As proposed, metallic or resilient can and bottle engaging elements are attached at alternating points to a length of chain. The chain, with cans and bottles engaged, is attached to a string or rope and suspended in water for cooling. Conceivably, such a device could be adapted for child use but the inherent design requirement of a length of chain with a multiplicity of attachments is a built in and unacceptable safety hazard.

U.S. Pat. No. 5,702,039 depicts a utility belt utilizing hook and loop fasteners that is adjustably attached to two sides of a stroller in front of the occupant and includes a plurality of object holding tethers, some affixed removably at one end to the transverse strap and at the other end providing additional hook and loop fasteners for the attachment of objects. An additional tether is at one end permanently attached to the transverse strap. The other end is provided with and attached to a device specifically designed to engage a baby bottle. The shortfalls in this overly complicated proposal begin with the requirement to affix the device through means of a transverse strap. Many methods of child transport do not have locations to which such a device could effectively be affixed. In addition, the multiplicity of releasably attached object holding tethers will likely be quickly and easily lost during a mother's busy day even considering average usage.

Finally, the ring shaped bottle engaging device on the fixed tether is specifically intended to retain a baby bottle by being placed between the lid and neck of the bottle. Retention of the bottle is effected by the tightening of the lid of the container down upon the neck such that the ring is secured there between. It is likely that not all baby bottles will fit such a non-standardized device. If this attachment is somehow broken, chewed off or lost, the utility belt can provide only impaired utilization. As this strap is permanently affixed to the transverse strap at one end and the bottle retaining ring at the other end, replacing or re-filling the bottle is needlessly complicated due to the need to disassemble the bottle assembly during use in potentially less than optimal circumstances and with attendant exposure to unpredictable septic environmental conditions.

U.S. Pat. No. 6,131,780 illustrates a method of carrying a bottle of liquid consisting of a nylon web belt attached to an assembly of nylon cord with a spring loaded toggle clip. The cord is placed over a bottle neck and the length of the cord surrounding the bottle neck is adjusted by sliding the toggle clip to the point where it touches and encircles and thus restrains the bottle. Though ergonomically well-suited to adult sporting, recreation and other uses as emphasized in this patent's documentation, use of this device by children under a certain size and age could easily be fatal due to the designed in presence of a significant choking hazard. The potential for the child to inadvertently strangle himself while experimenting with the various J-clips, sliding clasps and toggled nooses or loops is very high.

U.S. Patent Application U.S. 2002/0005418 A1 for a bottle connector follows a similar course in describing a device intended to removably connect a bottle manufactured with an annular ridge or groove in the neck to an individual. As expressed in drawing number one the preferred embodiment of the device—adjustable resiliently deformable elastic collars or O-rings—are attached to a rigid ring like a key ring which is in turn releasably attached to an elongated strap through means of a swivel clip or some other device.

The underlying retention methodology of this device is for the user to resiliently deform the appropriately sized collar or 0-ring such that when slipped over a bottleneck with an annular groove or ridge and tensionally adjusted, a secure frictional association upon the bottleneck is resultant which requires a similar force to be disengaged. This device is also primarily intended for use by adults or older children where the personal retentioning intent of the device is fundamental to their world view. The basic function and design, however, present a number of likely hazards for smaller children.

Infants and younger children are quite capable of generating enough compression force with sufficient dexterity during their increasing explorations of the outside world to release the tensional engagement of the O-rings causing loss, damage or contamination of the bottle. The most important shortfall in the preferred embodiment is shared by most approaches of this type; a noose-like strap is utilized to effect the attachment of the device to a location of the user's choice with all the attendant potentially lethal hazards such a design entails with small children.

A second embodiment noted replaces the strap on the rigid ring with a simple tensional clip consisting of a swivel at one end interconnecting the clip and rigid ring. At the opposite end of the clip a hook is formed. The mouth of the hook is completed by a spring tensioned retractable rod received into the body of the device which allows the hook to be opened and closed. Through this means is the bottle connector then attached to a location of the user's choice. Once,again, tests show that this simple retention method is easily defeated by even small children with previously noted consequences for the retained item.

U.S. Patent Application US 2002/0046984 A1 for a Bottle Clip is expressed as a beverage container holder that is small and flexible. This device is composed of a support member having first and second loops, the first and second ends of which are attached to one another to form a circular shape, an adjustment means for attaching a beverage container to the first loop of the support member, and a clip attached to the second loop of the support member for removably securing the holder to the user's clothes or accessories.

This proposal effects bottle retention through another version of the adjustable noose or loop approach. The support member is removably attached to the user through means of the associated flexible clip. The bottle is attached to the support member by tightening the loop or noose formed around the bottle neck and securing it snugly with a spring loaded clip or other compressive tensional method.

Here again we believe that the device proposed, though suitable for use by adults and older children, is too easily detached or released by small children and presents the expected choking hazard shown in previous examples that employ this technique of retention.

U.S. Patent Application No. US 2003/0121944 A1 discloses a tether for objects such as infant drinking devices. The tether is described as including a ring, a first strap connected to the ring at a first point, a first end of the second strap coupled to one end of the first strap and ring assembly, and a releaseable connector utilizing the hook and loop method of retention. This method of closure is operable to releasably couple the first strap to the ring at a second point such that the first strap forms a variable sized opening for receiving the container that when adjusted properly produces sufficient tensional friction to maintain the position of the bottle. The second strap is provided on the second end with a permanent loop large enough to permit slipping over an adult hand. By passing one end of the assembly around an object and back through the loop on the second end of the second strap, one can attach the bottle to the object.

This particular reference does not address the ease with which a child can remove and replace loop and hook closures thus foiling the intended use of the device by losing the restrained object. More importantly, the easily releasable and recloseable hook and loop closure with a ring or other linking device creates an almost irresistible opportunity for a child to accidentally garrote or asphyxiate himself. When combined with the manufactured-in attachment loop on the second end of the second strap, the grave potential generated by this device for accidents of this nature to ensue is greatly magnified.

U.S. Patent Application No. US 2004/0061031 A1 discloses a baby bottle holder that is composed of a stuffed toy body containing an internal sleeve into which a baby bottle is inserted and a flexibly engaging bottle retainer just inside the opening to assist in positioning and retaining the bottle within the sleeve. A tether is provided to attach the baby bottle holder to the user or an accessory device.

This device is to be used by babies and children and does effectively hold the baby bottle holder attached to some object.

However, though the extractive force for the bottle is likely greater than a baby could apply, a small child could easily extract the bottle from the elastic retainer in the bottle holder and initiate loss of the bottle. As a result, it appears that this device is suitable for use only by babies and so fails to address the needs of older stronger children. In general, the added weight and bulk of the stuffed animal may offset any of the perceived benefits of the design for any but the youngest children.

### SUMMARY OF THE INVENTION

The present invention is generally directed to a tethering device for bottles, cups, containers and accessories that addresses the above basic background requirement issues and those noted specific deficiencies recognized in the prior art that is simple for adults to use, inexpensive and ergonomically child-safe.

More specifically, the invention is composed of three adjustable integrated straps made of webbing or elastic materials and multiple curved two-button self-locking buckle connectors the use of which will increase circumferential frictional engagement upon the held item and provide enhanced child-proofing qualities during use from the increased resultant tensional locking forces inherent in the two-button methodology.

A first strap is an adjustable length main connecting strap with a first end and a second end, each one of which terminates in a small loop whose internal circumference allows material of sufficient width or diameter to be drawn or to easily slide.

A second strap, to be attached to the bottle, is an adjustable length attachment strap assembly composed of two ends, one of which is permanently affixed to the female half of a pronged self-locking buckle type connector assembly and the other releasably attached to the male component of the same curved buckle assembly.

A third strap, to be attached to the stroller or other accessory, is an adjustable length attachment strap assembly composed of two ends, one of which is permanently affixed to the female half of a three pronged self-locking curved buckle type connector assembly and the other releasably attached to the male component of the curved buckle assembly. Of course other means to attach the first strap to the stroller or similar stationary object might be used however the current preferred mode features a third strap.

The symbiotic combination of sliding and adjustable straps, the curvature and improved clasping effect of the utilized tension controlled locking buckles, and the need for simultaneous pressure on both of the opposing tension release buttons in order to disengage the clamping effect of the second strap assembly upon the held device is the key to this invention's enhanced provision of safe, child-resistant and secure bottle and accessory control.

Various additional straps with the appropriate curved buckle component on the distal ends could be provided in a kit with the device for random attachment to multiple devices like high chairs, strollers etc. Though envisioned as nylon webbing for this application, the various straps noted could be made of rubber, elastic or otherwise resilient materials which could further enhance performance. Employing curved two-button locking buckle assemblies is preferably proposed for their improved gripping and locking capabilities on cylindrical surfaces; the use of straight connectors with one or two buttons could be potentially employed if the desired capabilities were to be conserved.

### BRIEF DESCRIPTION OF DRAWING FIGURES

FIG. 1 is an embodiment of the components of the device as assembled in a cross sectional view and outlining the components.

FIG. 2 is a cross sectional view of the circumferential frictional forces provided by the various straps and curved tensional buckle connectors when in use.

FIG. 3 is a side view of the curved tensionally locking buckle connectors and the two tension lock buttons—one assembled and one disassembled.

FIG. 4 is a side view of an embodiment of the device in use.

FIG. 5 is a top view of another preferred embodiment of the device having means for adjustment of the straps.

### DETAILED DESCRIPTION OF PREFERRED EMBODIMENTS OF THE DISCLOSED DEVICE

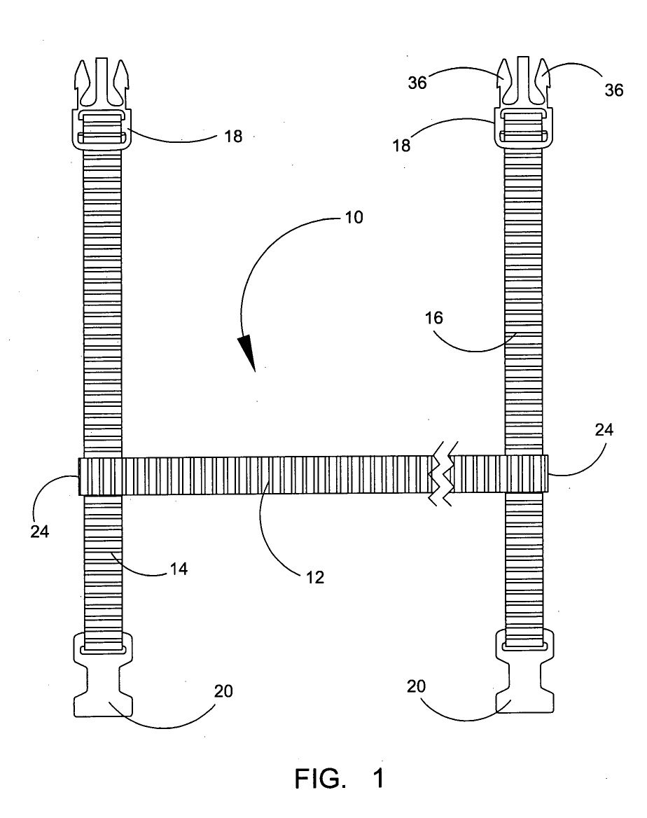

Referring now to the drawings, FIGS. 1-5 disclose the preferred embodiments of the herein disclosed as a tether device 10 to restrain a child's bottle or other type of drinking vessel or other item which may need restraining from dropping or throwing by the child.

Referring to FIG. 1 there is shown the assembled bottle tether device 10 and its preferred embodiments which include components from other figures. A first preferred embodiment of the bottle tether device 10 is shown in FIG. 1. All embodiments of device 10 feature a number of common components. These include webbing or elastic material or plastic material forming the connection strap 12, bottle retention strap 14 and attachment strap 16 which adapts the device for attachment to a fixed object such as a crib or stroller or high chair. Of course other means to engage the connection strap 12 to a fixed position might be used however the attachment strap 16 is employed in the current favored mode. Also means for strap position adjustment is provided in the depicted form of a slidably adjustable loop 24, and means for engagement of the distal ends of the connection strap 12 and the attachment strap 16 is provided by depicted engaged buckle 26.

In the preferred embodiments the bottle retention strap 14 is engaged with an attachment strap 16, through respective cooperative engagement at the distal ends of the connection strap 12. Engagement of the distal ends of the bottle retention strap 14 and attachment strap 16 is provided by means for engagement of the distal ends which in the current preferred embodiments features a male tensional buckle components 18 and female tensional adjustment components 20 which cooperatively engage and require opposing pressure of a finger and thumb to which an infant would not generally have. As best shown in FIG. 1 which depicts one preferred embodiment of the device 10, these components are assembled and are displayed as would be the case if laid out prior to use.

The strap lengths are best manufactured in the assembled device 10 employing a retention strap 14 which is compatible with the general sizes of the bottles 30 and accessories to be retained when the distal ends of the retention strap 14 are engaged. In the case of connection strap 12, a length reasonably calculated to restrain the bottle 30 or other engaged component from falling would be employed and as noted below, a means for length adjustment can be provided. As to the attachment strap 16, it would be formed in a length reasonably expected to encircle the most commonly encountered diameters of baby stroller, car seat and backpack assemblages which the device 10 is most likely to encounter.

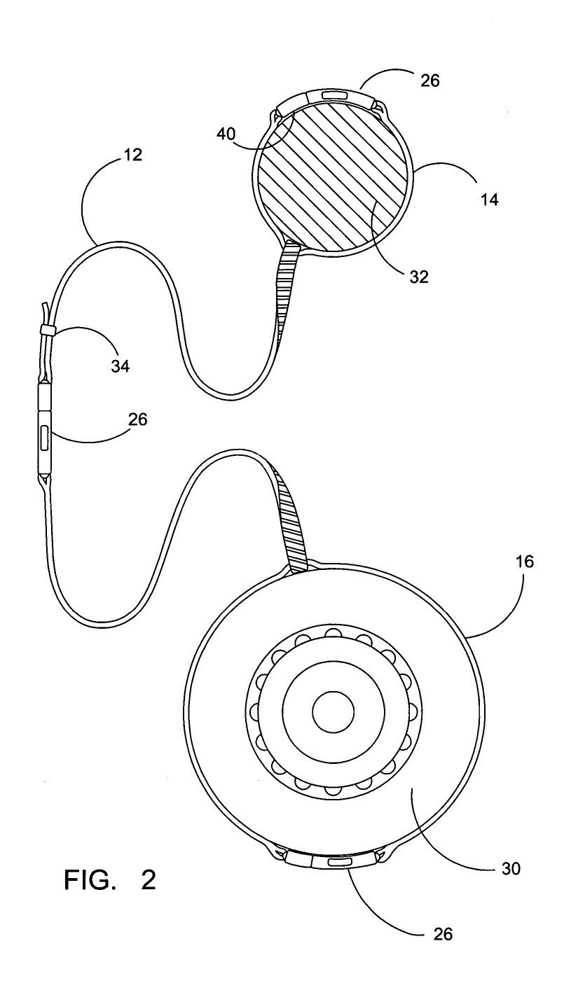

Operational characteristics of the device are shown in FIG. 2 in a cross sectional view of the force vectors generated by the compression resulting from the tensional engagement of the distal ends of the retention strap 14 using the buckle components 18 and 20 subsequent to the enmeshment of those components to form completed tensional buckle assembly 26 on each of the retention strap and attachment strap 16. In the preferred embodiments of the device 10 one or both of the male buckle component 18 and female buckle component 20 may be adjusted in their position on the distal ends of their respective straps. This is accomplished by a slidable engagement on the respective distal ends and the employment of a sliding buckle engaged on the straps to thereby adjust the total length of each strap. This total length adjustment of the respective strap 12, 14, or 16, is accomplished by sliding the strap material through its slidable frictional engagement with one of the male component 18 or female component to position it on the distal end with the respective strap being the proper length. Then the terminal end 40 of the strap which is engaged with the sliding buckle 34 is moved to a fixed position in a mid-portion of the strap so adjusted to complete the length changing process.

As noted this means for adjustment of the total length of any or all of the three straps provides the user with the utmost adjustability to the task at hand. As best shown in FIG. 5, the connection strap 12, and/or the retention strap 14 and/or the attachment strap 16 can be employed through the provision of the slidable engagement of at least one of the male component 18 or the female component 20 on the distal end of the appropriate strap with the terminal end 38 of the respective strap being engaged upon the sliding buckle 34 for setting the final length of the strap being adjusted. Sliding the buckle 34 toward or away from the distal end of any strap will respectively lengthen or shorten it. This means for strap length adjustment can be used on one, two, or all three straps in the device 10 and in a current preferred mode of the device shown in FIG. 5, providing the most utility would be used on all three.

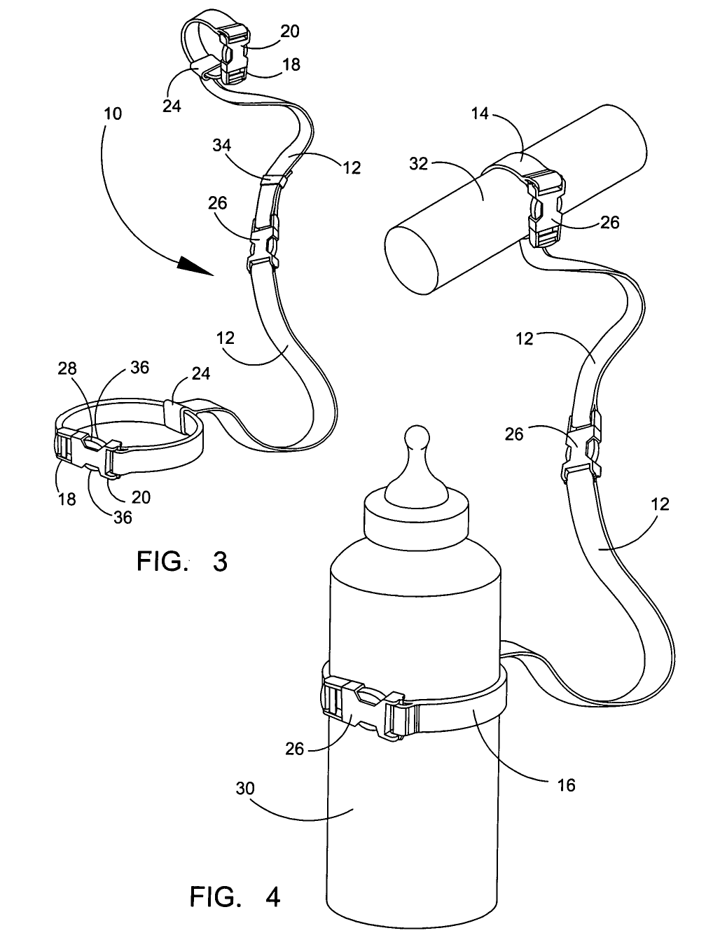

In use to secure a bottle 30 or other component from accidental or intentional falling, as best shown in FIG. 3, the retention strap 14 would be set to the proper length to achieve a compressed engagement around the circumference of a bottle 30 or other component using the aforementioned means for length adjustment. Since most modern baby bottles 30 and many toys are made from material with flexible walls, increased tensional engagement may be achieved by setting the total aggregate length of the retention strap to a length that will cause compression of the sidewalls of the bottle 30 when the strap is secured around its circumference. This will increase the frictional engagement of the retention strap 14 to the item being restrained.

By engaging the male component 18 and female component 20 upon retention strap 14 followed by the compressive insertion of the male 18 into the respective female components 20, sufficient compressive circumferential frictional forces are thereby generated to retain the controlled item such as bottle 30 within the retention 14. As noted, setting the length slightly smaller than the circumference of a bottle 30 or other restrained component having flexible walls increases this frictional force. This is shown in FIG. 2 as the generalized forces resultant of the communication engendered by the retention strap 12 and engagement of the buckle assembly 26.

As the device is intended to restrain components most often used by infants and toddlers, it is of a decided advantage to employ components to secure the distal ends of the engaged straps which require both manual dexterity as well as physical requirements lacking in the child. Children learn quickly how to attach and unattach devices by watching their parents' or caretakers' actions in securing them and unfastening them. Consequently, employment of buckle components which require more force and/or dexterity to disengage than most children have, is a desired element of this device 10. Shown in FIG. 3 is a side view of an assembled buckle assembly 26 which employs dual tensionally controlled locking buttons 28 on the ends of the flexible forks 36 of the male component 18 of the buckle assembly 26. When engaged in the female component 20, these locking buttons 28 are in the current preferred mode of the device, outwardly biased with a force that is beyond the grasp of most young children and which requires a dexterity of thumb and forefinger lacking in most children. Further the two distal ends of the male component 18 when engaged with the female component 20, are recessed into notches in the female component 20 making them even harder for an infant or toddler to access. A means to disengage the retention strap 14 from the attachment strap 16 is optionally provided by placing an engaged buckle 26 in a center portion of the connection strap. This optional engagement can be used with any of the embodiments herein if such a disengagement option is desired and would preferably be included in the current favored embodiment to provide maximum flexibility to the user.

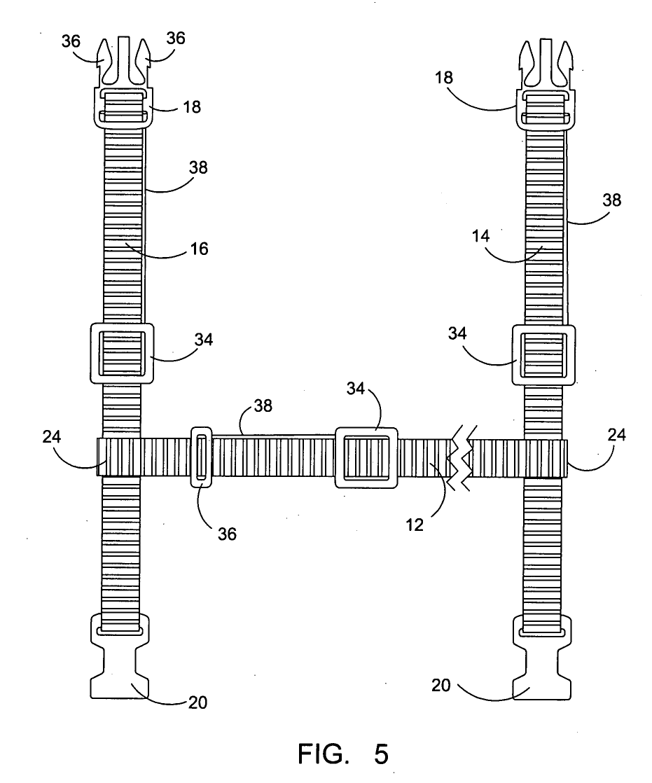

FIG. 4 is a view of the bottle tether device 10 in use which displays the bottle 30 or other item constrained through the compressive frictional forces resulting from the slidable adjustment and compressive assembly of the device 10 by the retention strap 14. Connecting strap 12 is shown communicating with attachment strap 16 which provides the attachment to the stroller or other base attachment 32.

Additionally, experimentation with the numerous embodiments of device 10 in engaging components such as a bottle 30 has shown that employing a buckle assembly 26 which when assembled from the male component 18 and female component 20 has a curved inner surface 40 adjacent to the bottle 30 being engaged provides a much better tensional engagement around the circumference of the bottle 30 due to the maximization of the contacts between the bottle 30 and the curved inner surface 40. While using a buckle assembly 26 which has a flat inner surface 40 will work reasonably well with sufficient tensional engagement of the straps, the curved inner surface 40 has been found to substantially enhance the tensional engagement with curved components such as the bottle 30, thereby enhancing the performance of the device 10, and consequently such a curved inner surface is highly desirable in the device 10 in use in the preferred embodiment.

The most adjustable embodiment of the device 10 is shown in FIG. 5 which depicts a top view of the device 10 employing a means for adjustment of the length of all three of connection strap 12, the retention strap 14 and the attachment strap 16. Employing the aforementioned of the slidable engagement of one of the male component 18 or female component 20 on the distal ends of the retention strap 14 and attachment strap and engaging the terminal end 40 of the respective strap to a sliding buckle 34, the total aggregate length of the individual strap is adjustable by the user for the task at hand. Adjustment of the connection strap 12 is provided in a similar fashion by slidable engagement of the distal end of the connecting strap 12 through a connection buckle 36 that is engaged with the attachment strap 16. The terminal end of the connection strap 12 would be secured to a sliding buckle 34 in the same fashion as the other straps. The total aggregate length of the connection strap 12 can be easily adjusted by sliding the buckle 34 to different positions on the connection strap 12.

Also shown in FIG. 5 is the means for slidable engagement of the connection strap 12 at its distal ends to retention strap 14 and the attachment strap 16. Experimentation with various embodiments of the device 10 has shown that this slidable engagement provides more adjustability and hence utility to the device 10 and in a preferred embodiment one or both of the distal ends of the connecting strap 12 would be engaged with one or both of the retention strap 14 and attachment strap 16.

Although the invention has been described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Any and all such changes, alternations and modifications as would occur to those skilled in the art, are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A tethering device comprising:
a retention strap having a first end, a second end, and having a center portion between said first end and said second end;
said retention strap having a retention strap length defined by the distance between said first end and said second end of said retention strap;
means for removable engagement of said first end of said retention strap to said second end of said retention strap;
a connector strap having a first end and a second end, a center section therebetween, and a connector strap length defined by the distance between said first end and said second end of said connector strap;
means for engagement of said first end of said connector strap to said center portion of said retention strap;
means for engagement of said second end of said connector strap to a fixed position; and
said retention strap length having a total length adapted to compressibly engage around sidewalls defining the circumference of an object to be restrained, when said first end of said retention strap is engaged with said second end of said retention strap in an engaged position around said circumference.

2. The tethering device of claim 1 further comprising:
means for biased engagement of said retention strap in said engaged position around said circumference of said object provided by:
said retention strap being elastic and having a retention strap length slightly smaller than said circumference of said object.

3. The tethering device of claim 1 further comprising:
means for biased engagement of said retention strap in said engaged position and said circumference of said object provided by:
said retention having a retention strap length slightly smaller than said circumference of said object and said object having a flexible sidewall defining said circumference.

4. The tethering device of claim 1 further comprising:
said retention strap length having a total length adapted to compressibly engage around curved sidewalls defining the circumference of an object to be restrained, when said first end of said retention strap is engaged with said second end of said retention strap in an engaged position around said circumference;
said means for removable engagement of said first end of said retention strap to said second end of said retention strap comprising a fastener, said fastener having a first component engageable with a second component to an engaged position;
said fastener in said engaged position having an inner surface contacting said object; and
said inner surface having a curved shape substantially similar to the curve of said sidewall defining said circumference to thereby maximize the contact between said inner surface and said sidewall.

5. The tethering device of claim 2 further comprising:
said retention strap length having a total length adapted to compressibly engage around curved sidewalls defining the circumference of an object to be restrained, when said first end of said retention strap is engaged with said second end of said retention strap in an engaged position around said circumference;
said means for removable engagement of said first end of said retention strap to said second end of said retention strap comprising a fastener, said fastener having a first component engageable with a second component to an engaged position;
said fastener in said engaged position having an inner surface contacting said object; and
said inner surface having a curved shape substantially similar to the curve of said sidewall defining said circumference to thereby maximize the contact between said inner surface and said sidewall.

6. The tethering device of claim 3 further comprising:
said flexible sidewalls of said objection defining a curved circumference;
said means for removable engagement of said first end of said retention strap to said second end of said retention strap comprising a fastener, said fastener having a first component engageable with a second component to an engaged position;
said fastener in said engaged position having an inner surface contacting said object; and
said inner surface having a curved shape substantially similar to the curve of said sidewall defining said circumference to thereby maximize the contact between said inner surface and said sidewall.

7. The tethering device of claim 1 further comprising:
means for adjustment of said retention strap length.

8. The tethering device of claim 2 further comprising:
means for adjustment of said retention strap length.

9. The tethering device of claim 3 further comprising:
means for adjustment of said retention strap length.

10. The tethering device of claim 4 further comprising:
means for adjustment of said retention strap length.

11. The tethering device of claim 5 further comprising:
means for adjustment of said retention strap length.

12. The tethering device of claim 6 further comprising:
means for adjustment of said retention strap length.

13. The tethering device of claim 1 further comprising:
releasable means for engagement of said first end of said connecting strap to said second end of said connector strap located at said center section, whereby said first end of said connecting strap may be removed and reattached to said second end of said connector strap.

14. The tethering device of claim 2 further comprising:
releasable means for engagement of said first end of said connecting strap to said second end of said connector strap located at said center section, whereby said first end of said connecting strap may be removed and reattached to said second end of said connector strap.

15. The tethering device of claim 3 further comprising:
releasable means for engagement of said first end of said connecting strap to said second end of said connector strap located at said center section, whereby said first end of said connecting strap may be removed and reattached to said second end of said connector strap.

16. The tethering device of claim 4 further comprising:
releasable means for engagement of said first end of said connecting strap to said second end of said connector strap located at said center section, whereby said first end of said connecting strap may be removed and reattached to said second end of said connector strap.

17. The tethering device of claim 5 further comprising:
releasable means for engagement of said first end of said connecting strap to said second end of said connector strap located at said center section, whereby said first end of said connecting strap may be removed and reattached to said second end of said connector strap.

18. The tethering device of claim 6 further comprising:
releasable means for engagement of said first end of said connecting strap to said second end of said connector strap located at said center section, whereby said first end of said connecting strap may be removed and reattached to said second end of said connector strap.

19. The tethering device of claim 7 further comprising:
releasable means for engagement of said first end of said connecting strap to said second end of said connector strap whereby said first end of said connecting strap may be removed and reattached to said second end of said connector strap.

20. The tethering device of claim 11 further comprising:
releasable means for engagement of said first end of said connecting strap to said second end of said connector strap whereby said first end of said connecting strap may be removed and reattached to said second end of said connector strap.

21. The tethering device of claim 4 further comprising:
releasable means for engagement of said first end of said connecting strap to said second end of said connector strap whereby said first end of said connecting strap may be removed and reattached to said second end of said connector strap.

22. The tethering device of claim 1 further comprising:
said means for engagement of said first end of said connector strap to said center portion of said retention strap provides a sliding engagement whereby said retention strap is translatable in its engagement to said connector strap.

23. The tethering device of claim 4 further comprising:
said first competent engageable to said second component by engagement of a distal end on each of two forks in one of said first or second component, with apertures in the other of said first or second component;
said forks having an outward bias to compressed engagement of said distal ends in said aperture; and
said outward bias calculated to be in excess of the force applicable by a child to compress said forks and disengage said distal ends from said apertures.

24. The tethering device of claim 5 further comprising:
said first competent engageable to said second component by engagement of a distal end on each of two forks in one of said first or second component, with apertures in the other of said first or second component;
said forks having an outward bias to a compressed engagement of said distal ends in said aperture; and
said outward bias calculated to be in excess of the force applicable by a child to compress said forks and disengage said distal ends from said apertures.

25. The tethering device of claim 23 further comprising:
said distal ends having a curved exterior surface exposed through said apertures; and
said curved surface causing said first component to eject from said second component when said forks are compressed.

26. The tethering device of claim 24 further comprising:
said distal ends having a curved exterior surface exposed through said apertures; and
said curved surface causing said first component to eject from said second component when said forks are compressed.
